(19) United States
(12) Patent Application Publication
(10) Pub. No.: US 2020/0334499 A1
(43) Pub. Date: Oct. 22, 2020

(54) VISION-BASED POSITIONING METHOD AND AERIAL VEHICLE

(71) Applicant: SZ DJI TECHNOLOGY CO., LTD., Shenzhen (CN)

(72) Inventors: Dongdong MA, Shenzhen (CN); Yuewen MA, Shenzhen (CN); Kaiyong ZHAO, Shenzhen (CN)

(21) Appl. No.: 16/906,604

(22) Filed: Jun. 19, 2020

Related U.S. Application Data
(63) Continuation of application No. PCT/CN2017/117590, filed on Dec. 20, 2017.

(51) Int. Cl. G06K 9/62; G06K 9/00; G06T 7/00; G06T 7/60

(52) U.S. Cl. CPC G06K 9/6232; G06K 9/6212; G06K 9/627; G06T 2207/10028; G06T 7/0002; G06T 7/60; G06K 9/0063

(57) ABSTRACT

A vision-based positioning method includes extracting first features from a first image and second features from a second image, determining initial matching pairs according to the first features and the second features, extracting satisfying matching pairs that meet a requirement from the initial matching pairs according to an affine transformation model, and determining a position-attitude change according to the satisfying matching pairs. The first image and the second image are obtained by a vision sensor carried by an aerial vehicle. The position-attitude change indicates a change from a position-attitude of the vehicle when the vision sensor captures the first image to a position-attitude of the vehicle when the vision sensor captures the second image.

### CROSS-REFERENCE TO RELATED APPLICATION

This application is a continuation of International Application No. PCT/CN2017/117590, filed Dec. 20, 2017, the entire content of which is incorporated herein by reference.

### TECHNICAL FIELD

The present disclosure relates to the electronic technology field and, more particularly, relates to a vision-based positioning method and an aerial vehicle.

### BACKGROUND

With the development of electronic technology, aerial vehicles (e.g., unmanned aerial vehicles) have been widely used.

During flight, an aerial vehicle can continuously obtain images through a vision sensor (such as a monocular camera or a binocular camera) and estimate a position-attitude change of the aerial vehicle through the images to estimate a position of the aerial vehicle. The higher is the accuracy of the position-attitude change, the higher is the accuracy of the position of the aerial vehicle.

How to improve the accuracy of the change of the position-attitude is a popular research direction.

### SUMMARY

In accordance with the present disclosure, there is provided a vision-based positioning method. The method includes extracting first features from a first image and second features from a second image, determining initial matching pairs according to the first features and the second features, extracting satisfying matching pairs that meet a requirement from the initial matching pairs according to an affine transformation model, and determining a position-attitude change according to the satisfying matching pairs. The first image and the second image are obtained by a vision sensor carried by an aerial vehicle. The position-attitude change indicates a change from a position-attitude of the vehicle when the vision sensor captures the first image to a position-attitude of the vehicle when the vision sensor captures the second image.

In accordance with the present disclosure, there is provided an aerial vehicle, including a vision sensor, a processor, and a memory. The memory stores program instructions that, when executed by the processor, cause the processor to extract first features from a first image and second features from a second image, determine initial matching pairs according to the first features and the second features, extract satisfying matching pairs that meet a requirement from the initial matching pairs according to an affine transformation model, and determine a position-attitude change according to the satisfying matching pairs. The first image and the second image are obtained by a vision sensor carried by an aerial vehicle. The position-attitude change indicates a change from a position-attitude of the vehicle when the vision sensor captures the first image to a position-attitude of the vehicle when the vision sensor captures the second image.

### BRIEF DESCRIPTION OF THE DRAWINGS

FIG. 1 illustrates a schematic diagram of a scene for vision-based positioning according to some embodiments of the present disclosure.

FIG. 2 illustrates a schematic diagram of a scene for initializing an aerial vehicle according to some embodiments of the present disclosure.

FIG. 3A illustrates a schematic diagram of a scene for an initial matching and matching pair filtering for an aerial vehicle according to some embodiments of the present disclosure.

FIG. 3B illustrates a schematic diagram of a scene for guided matching for an aerial vehicle according to some embodiments of the present disclosure.

FIG. 4A illustrates a schematic diagram of a scene for a position-attitude calculation and 3D point cloud calculation for an aerial vehicle according to some embodiments of the present disclosure.

FIG. 4B illustrates a schematic diagram of a scene for a position-attitude change calculation using adjacent positions according to some embodiments of the present disclosure.

FIG. 5A illustrates a schematic flowchart of a vision-based positioning method according to some embodiments of the present disclosure.

FIG. 5B illustrates a schematic flowchart of another vision-based positioning method according to some embodiments of the present disclosure.

FIG. 6 illustrates a schematic flowchart of another vision-based positioning method according to some embodiments of the present disclosure.

FIG. 7 illustrates a schematic diagram of a scene for determining adjacent position points according to some embodiments of the present disclosure.

FIG. 8 illustrates a schematic flowchart of another vision-based positioning method according to some embodiments of the present disclosure.

FIG. 9 illustrates a schematic structural diagram of an aerial vehicle according to some embodiments of the present disclosure.

### DETAILED DESCRIPTION OF THE EMBODIMENTS

Technical solutions of embodiments of the present disclosure are described in connection with accompanying drawings of embodiments of the present disclosure.

An aerial vehicle (e.g., an unmanned aerial vehicle) may calculate the position of the aerial vehicle in real-time through a vision odometer. The vision odometer is a system (including hardware and method) to implement a movement estimation dependent on a vision sensor (such as a monocular or a binocular camera).

A vision odometer, for example, an open-source semi-direct monocular visual odometry (SVO) system or an oriented fast and rotated brief simultaneous localization and mapping (ORB SLAM) system, can calculate a position-attitude change of the aerial vehicle through a video stream and obtain a position of the aerial vehicle based on the position-attitude change. However, for some specific scenes (e.g., having a lot of repeated textures, such as grassland, farmland, etc.), such vision odometer can only extract a few matching pairs, which causes the position-attitude change of the aerial vehicle to have low accuracy. In this disclosure, “position-attitude” refers to position and/or attitude, and, correspondingly, a “position-attitude change” refers to a change in position and/or attitude, i.e., a change in at least one of position or attitude.

To improve the position-attitude change accuracy of the aerial vehicle, embodiments of the present disclosure provide a vision-based positioning method and an aerial vehicle.

In some embodiments, the vision-based positioning method provided by embodiments of the present disclosure may be applied in the SVO system.

In the vision-based positioning method, the aerial vehicle can use the vision sensor (such as a monocular camera or a binocular camera) to capture an image with a certain time interval/distance interval. In some embodiments, the aerial vehicle also records the time moment when the aerial vehicle captures the image, and uses a positioning sensor to record positioning information in real-time when the aerial captures the image, i.e., the position information regarding the position at which the aerial captures the image.

The vision-based positioning method provided by embodiments of the present disclosure may include a tracking thread and a mapping thread. The tracking thread is a process of using a current image currently captured by the aerial vehicle and a last image captured right before the aerial vehicle captures the current image to calculate a displacement of a position when the aerial vehicle captures the current image, i.e., the position at which the aerial vehicle captures the current image, as compared to a position when the aerial vehicle captures the last image, i.e., the position at which the aerial vehicle captures the last image.

The mapping thread is a process of outputting positions of features of the current image in a three-dimensional (3D) space, i.e., establishing a 3D point cloud map, according to the current image and the last image.

In some embodiments, when the aerial vehicle determines the current image as a keyframe, the aerial vehicle executes processes of the mapping thread. In some embodiments, the aerial vehicle executes the processes of the mapping thread for each image obtained.

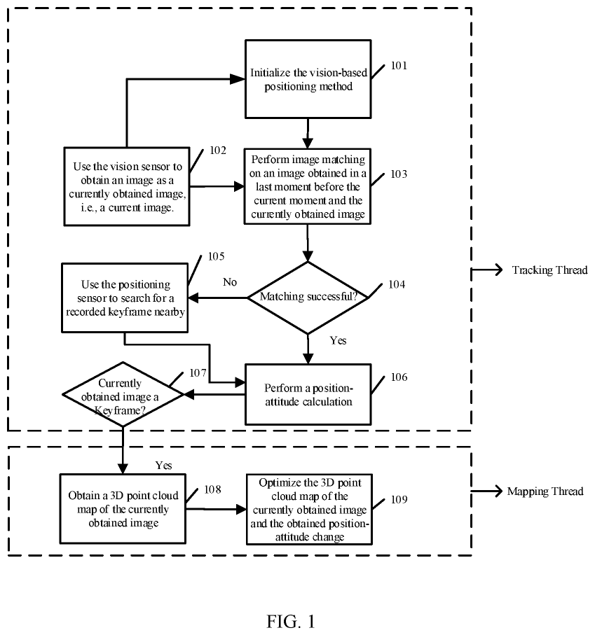

FIG. 1 illustrates a schematic diagram of a scene for vision-based positioning according to some embodiments of the present disclosure. In FIG. 1, the tracking thread include processes indicated by 101 to 107, and the mapping thread includes the processes indicated by 108 and 109.

At 101, the aerial vehicle initializes the vision-based positioning method.

In some embodiments, when the displacement of the aerial vehicle along a horizontal direction reaches a threshold, the aerial vehicle uses image 1 (i.e., a third image) and image 2 (i.e., a fourth image) to initialize the vision-based positioning method. The displacement of the aerial vehicle along the horizontal direction is also referred to as a “horizontal displacement” of the aerial vehicle.

At 102, the aerial vehicle uses the vision sensor to obtain an image as a currently obtained image, i.e., a current image.

The aerial vehicle can use the vision sensor to obtain the image in real-time and store the obtained image, a time moment of obtaining, and positioning information when capturing the image.

At 103, the aerial vehicle performs image matching on an image obtained in a last moment before the current moment (i.e., a last image, in some embodiments, the last image is a first image) and the currently obtained image (in some embodiments, the currently obtained image is a second image).

In some embodiments, the image matching may include processes of initial matching, matching pairs filtering, and guided matching.

At 104, the aerial vehicle determines whether the matching is successful. In some embodiments, if an image overlap rate of two images is lower than a predetermined overlap threshold, the matching may be unsuccessful.

If the matching is unsuccessful, then at 105, the aerial vehicle uses the positioning sensor to search for a recorded keyframe (i.e., a fifth image) nearby.

At 106, the aerial vehicle performs a position-attitude calculation according to the keyframe and the currently obtained image to obtain a position-attitude change of a position-attitude of the aerial vehicle at the time of capturing the currently obtained image as compared to a position-attitude of the aerial vehicle at the time of capturing the keyframe.

If the matching at is determined to be successful at 104, then at 107, the aerial vehicle performs the position-attitude calculation according to the last image and the currently obtained image to obtain a position-attitude change of the position-attitude of the aerial vehicle at the time of capturing the currently obtained image as compared to a position-attitude of the aerial vehicle at the time of capturing the last image.

In some embodiments, the aerial vehicle executes the mapping thread for each currently obtained image. In some embodiments, when the currently obtained image is the keyframe, the aerial vehicle may execute the processes of the mapping thread.

At 108, the aerial vehicle obtains a 3D point cloud map of the currently obtained image according to effective features extracted from the currently obtained image. At 109, the aerial vehicle optimizes the 3D point cloud map of the currently obtained image and the obtained position-attitude change (the position-attitude change of the position-attitude of the aerial vehicle at the time of capturing the currently obtained image as compared to the position-attitude of the aerial vehicle at the time of capturing the last image, or the position-attitude change of the position-attitude of the aerial vehicle at the time of capturing the currently obtained image as compared to the position-attitude of the aerial vehicle at the time of capturing the keyframe).

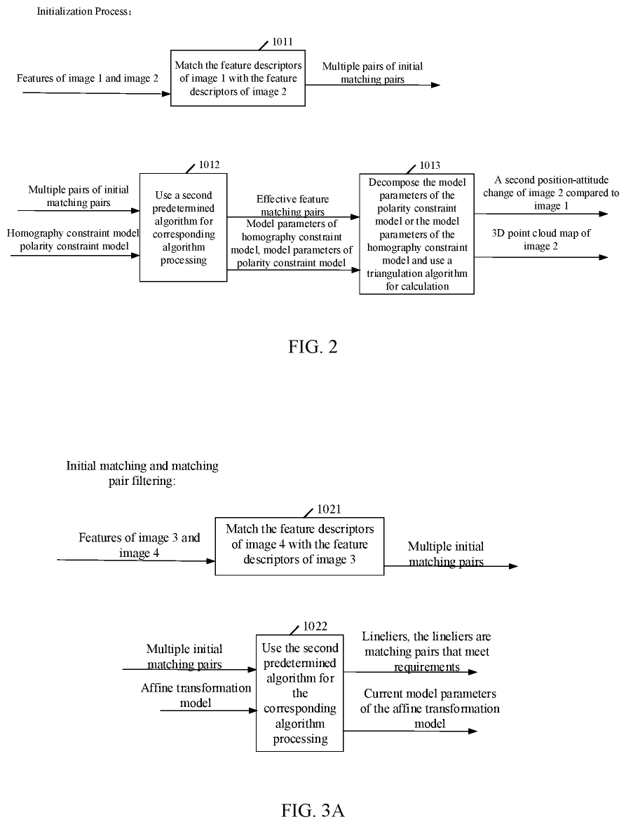

FIG. 2 illustrates a schematic diagram of a scene for initialization of the aerial vehicle according to some embodiments of the present disclosure. FIG. 2 shows further details of the process 101 shown in FIG. 1.

Before the initialization, the aerial vehicle can determine whether the displacement at the horizontal direction is larger than the threshold. If yes, the aerial vehicle can perform a vision-based positioning initialization process. If the aerial vehicle does not move in the horizontal direction, or the displacement at the horizontal direction is smaller than or equal to the threshold (e.g., the aerial vehicle is rotating in place, flying high, etc.), the aerial vehicle may not need to perform the vision-based positioning initialization.

At 1011, the aerial vehicle uses the vision sensor to obtain image 1 and image 2, obtain feature descriptors corresponding to features of image 1 and feature descriptors corresponding to features of image 2, and then match the feature descriptors of image 1 with the feature descriptors of image 2.

In some embodiments, the above features may include oriented fast and rotated brief (ORB) feature points, scale-invariant feature transform (SIFT) feature points, speeded up robust features (SURF) feature points, Harris corner points, etc. The above features may include other types of feature points, which are not limited by embodiments of the present disclosure.

In some embodiments, a matching process of the feature points may include matching a feature descriptor a of image 2 (i.e., a target feature descriptor) with at least some of the feature descriptors of image 1, and finding a feature point b of image 1 (i.e., a corresponding feature descriptor) with a smallest Hamming distance from the feature descriptor a. The aerial vehicle can further determine whether the Hamming distance between the feature descriptor a and the feature descriptor b is smaller than a predetermined distance threshold. If the Hamming distance is smaller than the predetermined distance threshold, the aerial vehicle can determine that the feature corresponding to the feature descriptor a and the feature corresponding to the feature descriptor b are a pair of initial feature matching pairs. By analogy, the aerial vehicle can obtain multiple pairs of initial feature matching pairs of image 1 and image 2.

In some embodiments, the aerial vehicle can also obtain feature descriptors corresponding to feature lines of image 1. The aerial vehicle further sets feature descriptors corresponding to feature lines of image 2. The aerial vehicle then matches the feature descriptors of image 1 with the feature descriptors of image 2 to obtain the multiple pairs of initial feature matching pairs.

In some embodiments, the feature lines may include line band descriptor (LBD) feature lines or other feature lines, which are not limited by embodiments of the present disclosure.

At 1012, the aerial vehicle inputs the obtained multiple pairs of initial feature matching pairs, a predetermined homography constraint model, and a polarity constraint model into a second predetermined algorithm for corresponding algorithm processing. The second predetermined algorithm may include, for example, random sample consensus (RANSAC).

By using the second predetermined algorithm for processing, the aerial vehicle can obtain multiple pairs of effective feature matching pairs filtered from the initial feature matching pairs, model parameters corresponding to the homography constraint model, or model parameters of the polarity constraint model.

In some embodiments, the aerial vehicle can use the second predetermined algorithm to perform algorithm processing on the multiple pairs of initial feature matching pairs and the homography constraint model. Further, the aerial vehicle uses the second predetermined algorithm to perform algorithm processing on the multiple pairs of initial feature matching pairs and the polarity constraint model.

If a result of the algorithm processing indicates that a matching result of the homography constraint model and the multiple pairs of initial feature matching pairs is more stable, the aerial vehicle can output the effective feature matching pairs and the model parameters of the homography constraint model. If the result of the algorithm processing indicates that a matching result of the polarity constraint model and the multiple pairs of initial feature matching pairs is more stable, the aerial vehicle can output the effective feature matching pairs and the model parameters of the polarity constraint model.

At 1013, the aerial vehicle decomposes the model parameters of the polarity constraint model or the model parameters of the homography constraint model (depending on the result of the algorithm processing in the above process), and combine the multiple pairs of effective feature matching pairs to obtain a second position-attitude change corresponding to image 1 and image 2 captured by the aerial vehicle. The second position-attitude change is used to indicate a change of a position-attitude when the vision sensor captures image 2 as compared to a position-attitude when the vision sensor captures image 1.

In some embodiments, the aerial vehicle can use a triangulation algorithm to generate a new 3D point cloud map of image 2 in the mapping thread. The aerial vehicle can also combine the new 3D point cloud map of image 2 to optimize the second position-attitude change.

In some embodiments, the aerial vehicle can store the second position-attitude change and the 3D point cloud map of image 2 as an initialization result.

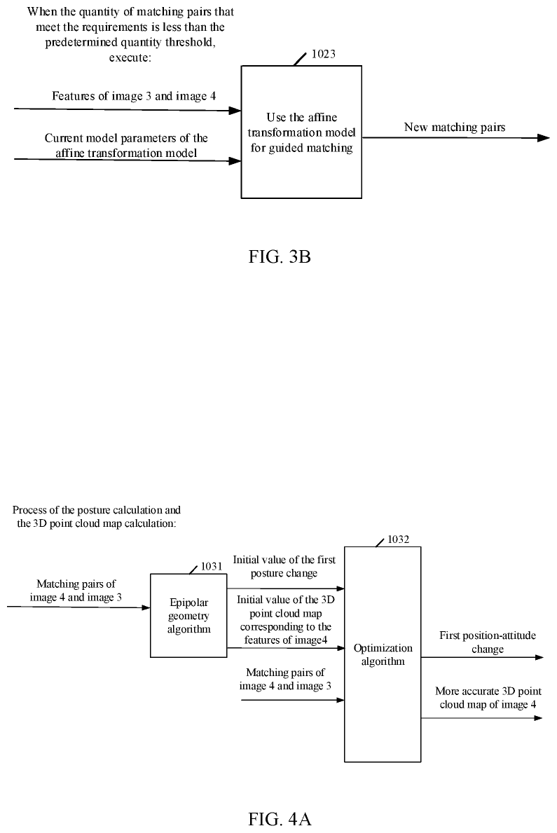

FIG. 3A illustrates a schematic diagram of a scene for an initial matching and matching pair filtering of an aerial vehicle according to some embodiments of the present disclosure. FIG. 3A shows further details of the image matching process at 103 shown in FIG. 1.

At 1021, the aerial vehicle uses the vision sensor to continue to obtain image 3 and image 4 and feature descriptors of image 3 and image 4. The aerial vehicle then matches the feature descriptors of image 4 with the feature descriptors of image 3.

In some embodiments, image 3 may be image 2, i.e., the first image may be the fourth image, which are not limited by embodiments of the present disclosure.

In some embodiments, the matching process includes matching a feature descriptor of feature c of image 4 with at least some of the feature descriptors of image 3, and finding feature d with a smallest Hamming distance to the feature descriptor of feature c of image 4. The aerial vehicle can further determine whether the Hamming distance between feature c and feature d is smaller than the predetermined distance threshold. If the Hamming distance is smaller than the predetermined distance threshold, the aerial vehicle can determine that the feature corresponding to feature c and the feature corresponding to feature d are a pair of initial matching pairs. By analogy, the aerial vehicle can obtain the multiple pairs of initial matching pairs of image 4 and image 3.

In some embodiments, when the aerial vehicle is in a scene having a lot of repeated textures, such as farmland or woods, using a saliency matching method commonly used by feature descriptors of some non-ORB feature points (hereinafter, such feature descriptors are also referred to as strong descriptors) may cause many effective matching pairs to be filtered out. Since the descriptors of ORB feature points are less salient than strong descriptors, the ORB feature points can be used for feature matching. The aerial vehicle may also use the method of determining whether the Hamming distance of the matching pair is less than the preset distance threshold, in which more initial matching pairs may be obtained.

However, by using the above ORB feature points and the method of determining using the Hamming distance, many invalid matching pairs are included in the initial matching pairs. Therefore, the aerial vehicle can pre-build an affine transformation model and filter the matching pairs through the affine transformation model to filter out these invalid matching pairs and increase the proportion of the effective matching pairs.

Due to the particularity of aerial vehicle photographing, corresponding features between two captured images can meet an affine transformation. Therefore, according to the affine transformation model, the invalid matching pairs can be filtered out from the initial feature matching pairs.

In some embodiments, at 1022, the aerial vehicle inputs the multiple pairs of initial matching pairs of image 2 and image 3 and the affine transformation model to the second predetermined algorithm for the corresponding algorithm processing to obtain multiple lineliers (the lineliers are matching pairs that meet a requirement after being filtered by the affine transformation model) and obtain current model parameters of the affine transformation model. In this disclosure, a matching pair meeting the requirement is also referred to as a satisfying matching pair.

In some embodiments, as shown in FIG. 3B, the aerial vehicle determines whether a quantity of the matching pairs that meet the requirements is less than a predetermined quantity threshold. If yes, at 1023, the aerial vehicle input the features of image 3, the features of image 4, and the current model parameters of the affine transformation model to the affine transformation model for guided matching to obtain more new matching pairs. A quantity of the new matching pairs is larger than or equal to the quantity of the matching pairs that meet the requirements.

The aerial vehicle can calculate the first position-attitude change according to the new matching pairs.

A stable quantity of the matching pairs is important for the aerial vehicle to calculate the position-attitude subsequently. When a lot of repeated textures appear in the scene, the quantity of the matching pairs meeting the requirements that are obtained based on the similarity between the feature descriptors may decrease sharply, which can cause a position-attitude calculation result of the aerial vehicle to have a low stability. By using the affine transformation model to guide the matching between the matching pairs, the aerial vehicle may obtain more new matching pairs in a region having a lot of repeated textures, which can greatly increase the stability of the position-attitude calculation result of the aerial vehicle.

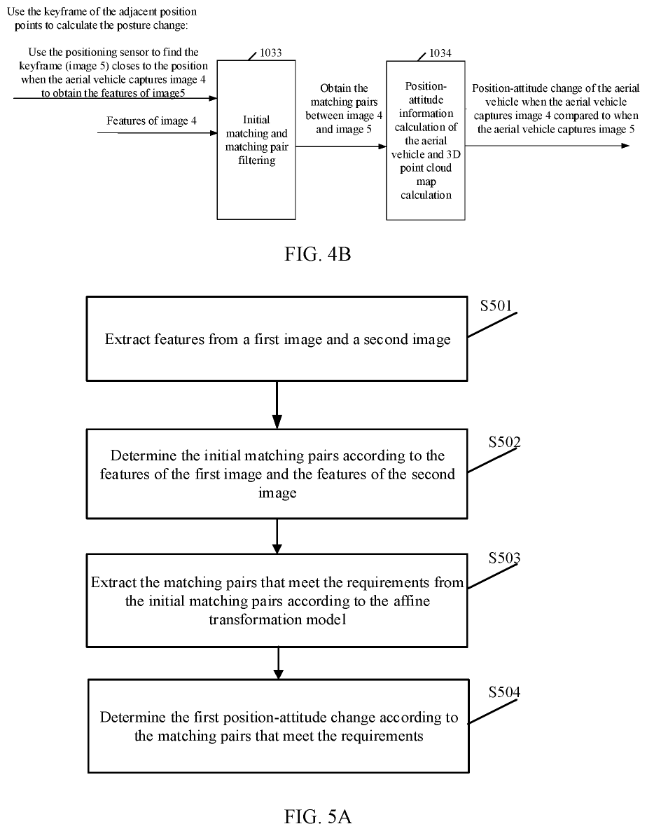

FIG. 4A illustrates a schematic diagram of a scene for a position-attitude calculation and 3D point cloud calculation of an aerial vehicle according to some embodiments of the present disclosure. An implementation process of the aerial vehicle position-attitude calculation and the 3D point cloud map calculation in FIG. 4A includes further details of the position-attitude calculation and the position-attitude optimization process shown in FIG. 1.

At 1031, the aerial vehicle processes the matching pairs that meet the requirements, according to an epipolar geometry algorithm (e.g., perspective-n-point (PnP) algorithm), to obtain an initial value of a 3D point cloud map corresponding to the features of image 4 and an initial value (i.e., the initial value of the first position-attitude change) of the position-attitude change of the aerial vehicle when capturing image 4 as compared to capturing image 3.

At 1032, according to an optimization algorithm (e.g., bundle adjustment (BA) algorithm), the aerial vehicle performs optimization processing on the initial value of the 3D point cloud map of image 4, the initial value of the position-attitude change of the aerial vehicle when capturing image 4 compared to capturing image 3, and the matching pairs of image 4 and image 3 to obtain a more accurate position-attitude change of the aerial vehicle when capturing image 4 as compared to capturing image 3, and obtain a more accurate 3D point cloud map of image 4.

Due to influences of wind speed and image transmission signals, for the images captured by the aerial vehicle, an overlap rate between two adjacent images may have a big change. A conventional method for calculating the position-attitude by using the optimization algorithm includes using a position-attitude corresponding to a last image as an initial value of optimization. When the overlap rate between the two adjacent images has a big change, continuously using the position-attitude corresponding to the last image as the initial value of the optimization algorithm may slow down the optimization and cause an unstable optimization result.

Embodiments of the present disclosure can use the epipolar geometry algorithm to calculate the initial value of the position-attitude change of the aerial vehicle. By using the initial value of the position-attitude change as the initial value of the optimization algorithm, convergence becomes faster during the optimization process.

In some embodiments, the above process of using the epipolar geometry algorithm and the optimization algorithm to calculate the position-attitude change may also be implemented for a fusion of the vision sensor and an inertial measurement unit (IMU).

In some embodiments, the aerial vehicle can store a position when the aerial vehicle captures image 3 and determine a position when the aerial vehicle captures image 4 according to the first position-attitude change and the position when the aerial vehicle captures image 3.

In some embodiments, when determining the position when the aerial vehicle captures image 4, the aerial vehicle may not be able to determine the first position-attitude change according to the matching pairs that meet the requirements. For example, when information of image 3 is lost, or the information of image 3 has an error, the aerial vehicle cannot determine the first position-attitude change. As shown in FIG. 4b, the aerial vehicle can determine positioning information when the aerial vehicle captures image 4 by using the positioning sensor. The aerial vehicle can search for an image (i.e., a fifth image) of an adjacent position point based on the positioning information of image 4, and use the image of the adjacent position point for matching.

At 1033, the aerial vehicle can use the positioning sensor and use the positioning information when capturing image 4 as a center to find an adjacent position point closest to the positioning information when capturing image 4 and obtain the feature of the keyframe (i.e., the image 5, also the fifth image) corresponding to the adjacent position point. The image 5 is an image with positioning information closest to the positioning information of image 4 besides image 3.

The aerial vehicle can perform the initial matching and matching pair filtering again on the features of image 4 and features of image 5 (For specific implementation process, reference may be made to the corresponding processes in FIG. 3A and FIG. 3B, which will not be repeated here.) to obtain matching pairs between image 4 and image 5.

At 1034, the aerial vehicle performs position-attitude information calculation for the aerial vehicle and 3D point cloud map calculation (For specific implementation process, reference may be made to the corresponding processes in FIG. 4A, which will not be repeated here.) according to the matching pairs between image 4 and the image 5 to obtain a position-attitude change (i.e., the third position-attitude change) of the aerial vehicle when capturing image 4 as compared to when capturing image 5.

Based on the vision-based positioning method described above, the aerial vehicle can calculate the position-attitude change of the position-attitude of the aerial vehicle at the time of capturing image 4 as compared to the position-attitude of the aerial vehicle at the time of capturing other images (such as image 3 or image 5). Based on the position-attitude change, the aerial vehicle can obtain relative position information. In some embodiments, the aerial vehicle can use a determined position of any image and the relative position information to obtain an absolute position of the entire moving trajectory of the aerial vehicle in the world coordinate system.

In a vision odometer method, the reference keyframe (such as image 3) can be continuously re-tracked using a mobile device if the first position-attitude change cannot be determined. However, in some embodiments, a flight route is planned before the aerial vehicle takes off. Returning to re-track after the tracking fails is difficult to implement. When the aerial vehicle cannot return to re-track, successful repositioning is impossible to be realized by continuously tracking the reference keyframe.

In embodiments of the present disclosure, the aerial vehicle can find the image closest to the current image according to the positioning information of the recorded images. Thus, the aerial vehicle can obtain a high success rate for repositioning.

The position of the aerial vehicle when the aerial vehicle captures an image is based on the position determined by the vision-based sensor. The positioning information of the aerial vehicle when the aerial vehicle captures the image is based on the position information determined by the positioning sensor. The position at which image 4 is captured calculated based on the vision-based sensor has a higher accuracy as compared to the positioning information when the aerial vehicle captures image 4 obtained by using the positioning sensor.

In some embodiments, the vision-based positioning method may be applied to a SLAM system.

When the vision-based positioning method is applied in the region with a lot of repeated textures (such as grassland, farmland, etc.), the accuracy of the positions obtained when the aerial vehicle captures the images is higher than the accuracy of the positions calculated by using the vision odometer method (such as open-source SVO system, or ORB SLAM system).

Method embodiments of the present disclosure are described below. Method embodiments of the present disclosure may be applied to the aerial vehicle. The aerial vehicle is provided with the vision sensor.

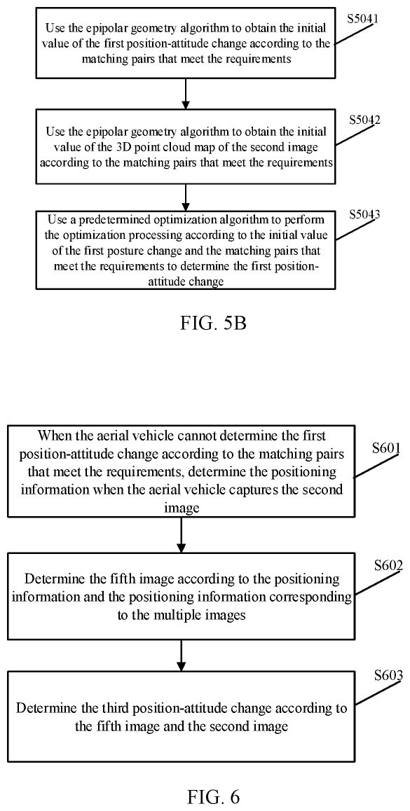

FIG. 5A illustrates a schematic flowchart of a vision-based positioning method according to some embodiments of the present disclosure. The method shown in FIG. 5A includes the following processes.

At S501, the aerial vehicle extracts features from a first image and a second image.

The first image and the second image are the images obtained by the vision sensor. The features of the first image are also referred to as “first features,” and the features of the second image are also referred to as “second features.”

The vision sensor may be a monocular camera, a binocular camera, etc., which is not limited by embodiments of the present disclosure.

In some embodiments, the features may include ORB feature points.

In some embodiments, the features may include feature lines. The feature lines may include LBD feature lines or other types of feature lines, which are not limited by embodiments of the present disclosure.

The aerial vehicle can add the feature lines and feature descriptors corresponding to the feature lines to improve a probability of the successful feature matching between images in a scene with missing textures to improve the stability of the system.

In some embodiments, due to the particularity of parallel capturing of an unmanned aerial vehicle (UAV), a size change between the images is very small. Therefore, the UAV can extract features from an image pyramid with fewer levels, and determine the initial matching pairs according to the extracted features, which can increase an extraction speed and increase a quantity of the initial matching pairs.

To enable the vision-based positioning method to operate stably when the overlap rate between the images is low, and to facilitate the improvement of the repositioning success rate of the vision odometer, the UAV can control the extracted features of the images to distribute uniformly.

At S502, the aerial vehicle determines the initial matching pairs according to the features of the first image and the features of the second image. In some embodiments, determining the initial matching pairs according to the features of the first image and the features of the second image may include determining the initial matching pairs according to the Hamming distance between the feature descriptors of the second image and the feature descriptors of the first image.

The Hamming distance may be used to measure a distance relationship between the feature descriptors. In general, the smaller the value of the Hamming distance is, the closer the two feature descriptors are. Therefore, matching performance is better.

The aerial vehicle can set a feature descriptor for each feature (including the feature point or the feature line) of the second image. The aerial vehicle can set a feature descriptor for each feature of the first image. The aerial vehicle can also determine the initial matching pairs based on the Hamming distance between the feature descriptors of the second image and the feature descriptors of the first image.

In some embodiments, determining the initial matching pairs according to the Hamming distance between the feature descriptors of the second image and the feature descriptors of the first image includes matching the target feature descriptor of the second image with the feature descriptors of the first image to obtain the corresponding feature descriptor with the closest Hamming distance to the target feature descriptor, and if the Hamming distance between the target feature descriptor and the corresponding feature descriptor is smaller than the predetermined distance threshold, determining the feature corresponding to the target descriptor and the feature corresponding to the corresponding descriptor as the pair of initial matching pairs.

In some embodiments, the aerial vehicle may use the feature descriptors corresponding to the ORB feature points to determine the Hamming distance. In the scene with many repeated textures such as farmland, woods, etc., many effective matching pairs may be filtered out by using the saliency matching method commonly used by the strong descriptors. However, the feature descriptors of the ORB feature points are less salient than the strong descriptors, more initial matching pairs may be found by using the method of determining whether the Hamming distance is less than the predetermined distance threshold.

Any of the feature descriptors of the second image may be used as the target feature descriptor. The corresponding feature descriptor is the feature descriptor of the first image with the closest Hamming distance to the target descriptor.

For example, the aerial vehicle may use each feature descriptor of the second image as the target feature descriptor. The aerial vehicle finds the feature descriptor corresponding to the target feature descriptor according to the Hamming distance. The aerial vehicle may further determine whether the Hamming distance between the target feature descriptor and the corresponding descriptor is smaller than the predetermined distance threshold. If yes, the aerial vehicle can use the feature corresponding to the target feature descriptor and the feature corresponding to the corresponding feature descriptor as an initial matching pair. By analogy, the aerial vehicle can find many pairs of initial matching pairs.

At S503, the aerial vehicle extracts the matching pairs that meet the requirements from the initial matching pairs according to the affine transformation model.

For the particularity of the parallel photographing by the aerial vehicle, the affine transformations are satisfied between two adjacent captured images. The affine transformation model can effectively filter the initial matching pairs.

The initial matching pairs are the matching pairs obtained by the aerial vehicle through the initial matching. The aerial vehicle can perform the matching pair filtering processing on the initial matching pairs through the affine transformation model. Therefore, the aerial vehicle can filter out the matching pairs that do not meet the requirements (such matching pairs are also referred to as noise) from the initial matching pairs and obtain the matching pairs that meet the requirements.

Meeting the requirements may mean meeting the filter requirements set by the affine transformation model. The meeting the requirements may also be other requirements for filtering initial matching pairs, which are not limited by embodiments of the present disclosure.

In some embodiments, extracting the matching pairs that meet the requirements from the initial matching pairs according to the affine transformation model includes using the first predetermined algorithm to obtain the matching pairs that meet the requirements according to the affine transformation model and the initial feature matching pairs, and the current model parameters of the affine transformation model.

In some embodiments, the first algorithm may be the RANSIC algorithm, or other algorithms, which is not limited by embodiments of the present disclosure.

For example, the aerial vehicle may input the affine transformation model and the multiple pairs of initial matching pairs to the RANSIC algorithm. The aerial vehicle uses the RANSIC algorithm to perform corresponding algorithm processing to obtain the matching pairs that meet the requirements (also called lineliers), and at the same time, obtain the current model parameters of the affine transformation model.

In some embodiments, determining the first position-attitude change according to the matching pairs that meet the requirements may further include determining the quantity of the matching pairs that meet the requirements, if the quantity of the matching pairs that meet the requirements is less than a predetermined quantity threshold, performing guided matching on the features of the first image and the features of the second image according to the current model parameters of the affine transformation model to obtain new matching pairs, and determining the first position-attitude change according to the new matching pairs.

The aerial vehicle can determine the positioning information of the second image according to the new matching pairs and the positioning information of the first image.

The quantity of the new matching pairs is larger than or equal to the quantity of the matching pairs that meet the requirements.

A stable quantity of the matching points is important to improve the accuracy of the positioning information of the second image. The aerial vehicle performs the guided matching on the features using the affine transformation model to obtain more matching pairs and improve the accuracy of the position-attitude change.

For example, the aerial vehicle can use the current model parameters of the affine transformation model obtained by filtering the matching pairs, the features of the first image, and the features of the second image as input parameters to perform the guided matching. As such, the aerial vehicle obtains the new matching pairs and determines the first position-attitude change according to the new matching pairs.

At S504, the aerial vehicle determines the first position-attitude change according to the matching pairs that meet the requirements.

The first position-attitude change is used to indicate the change of the position-attitude when the vision sensor captures the second image as compared to the position-attitude when the vision sensor captures the first image.

In some embodiments, the aerial vehicle can calculate the position when the aerial vehicle captures the second image according to the first position-attitude change and the position (pre-recorded) when the aerial vehicle captures the first image.

In some embodiments, the first image may be an image captured by the aerial vehicle through the vision sensor before the aerial vehicle captures the second image.

In some embodiments, determining the first position-attitude change according to the matching pairs that meet the requirements may include the following processes shown in FIG. 5B.

At S5041, the aerial vehicle uses the epipolar geometry algorithm to obtain the initial value of the first position-attitude change according to the matching pairs that meet the requirements.

In some embodiments, using the epipolar geometry algorithm to obtain the initial value of the first position-attitude change according to the matching pairs that meet the requirements includes using the perspective-n-point (PnP) algorithm to obtain the initial value of the first position-attitude change according to the matching pairs that meet the requirements.

The initial value of the first position-attitude change may represent an initial value for indicating the change of the position-attitude when the visual sensor captures the second image as compared to the position-attitude when the visual sensor captures the first image.

At S5042, the aerial vehicle uses the epipolar geometry algorithm to obtain the initial value of the 3D point cloud map of the second image according to the matching pairs that meet the requirements.

The aerial vehicle may further use the epipolar geometry algorithm to obtain the initial value of the 3D point cloud map corresponding to the features of the second image according to the matching pairs that meet the requirements. The features of the second image are the features extracted from the second image in the matching pairs that meet the requirements.

In some embodiments, the aerial vehicle can use the epipolar geometry algorithm to obtain the initial value of the first position-attitude change and the initial value of the 3D point cloud map of the second image according to the matching pairs that meet the requirements.

At S5043, the aerial vehicle uses a predetermined optimization algorithm to perform the optimization processing according to the initial value of the first position-attitude change and the matching pairs that meet the requirements to determine the first position-attitude change.

The predetermined optimization algorithm may be the BA algorithm.

For example, the aerial vehicle can perform the optimization processing on the initial value of the first position-attitude change, the initial value of the 3D point cloud map of the second image, and the matching pairs that meet the requirements according to the BA algorithm to obtain the first position-attitude change.

The first position-attitude change so obtained has a higher accuracy as compared to the initial value of the first position-attitude change.

In some embodiments, the aerial vehicle may further perform the optimization processing through the predetermined optimization algorithm according to the initial value of the first position-attitude change, the initial value of the 3D point cloud map of the second image, and the matching pairs that meet the requirements to determine the first position-attitude change and the 3D point cloud map of the second image.

The aerial vehicle may determine the position when the aerial vehicle captures the second image according to the first position-attitude change and the (predetermined) position when the aerial vehicle captures the first image.

In some embodiments, if the information of the first image is lost, or the information of the first image has an error, the aerial vehicle cannot determine the first position-attitude change according to the matching pairs that meet the requirements. Referring to FIG. 6, when the aerial vehicle cannot determine the first position-attitude change according to the matching pairs that meet the requirements, the aerial vehicle executes the following processes.

At S601, when the aerial vehicle cannot determine the first position-attitude change according to the matching pairs that meet the requirements, the aerial vehicle determines the positioning information when the aerial vehicle captures the second image.

The positioning sensor may be a global positioning system (GPS).

The positioning information when the aerial vehicle captures the second image can be determined by the positioning sensor.

In some embodiments, the aerial vehicle can store multiple images and the positioning information when the aerial vehicle captures each of the images during flight. The positioning information when the aerial vehicle captures the second image may be one of the multiple images.

At S602, the aerial vehicle determines the fifth image according to the positioning information and the positioning information corresponding to the multiple images.

The fifth image is an image with the positioning information closest to the positioning information of the second image beside the first image.

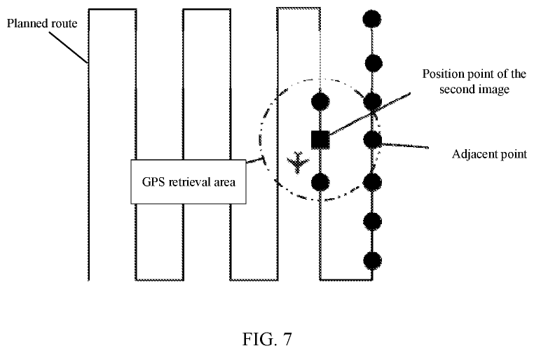

In some embodiments, as shown in FIG. 7, the positioning sensor is GPS. The aerial vehicle flies along a planned route.

The aerial vehicle may obtain a current image through the vision sensor during flight. The aerial vehicle also uses the last image obtained before obtaining the current image to obtain positioning information corresponding to the current image. When the last image obtained has an error, or a time difference of obtaining the two images is large, the aerial vehicle cannot determine the position-attitude change between the two images.

In FIG. 7, the aerial vehicle is at the position point of the second image. The aerial vehicle can determine the position point according to the positioning information when the aerial vehicle captures the second image obtained by the GPS. The aerial vehicle may use the position point of the second image as a center to plan a GPS retrieval area. All the position points in the GPS recovery area may form a retrieval area that can form a set of adjacent position points.

The aerial vehicle can determine the adjacent position point from the set of adjacent position points closest to the position of the second image beside the last image obtained.

In some embodiments, the aerial vehicle can determine the adjacent position points according to a lateral overlap rate. The aerial vehicle planned route is in the horizontal direction, and a direction perpendicular to an aerial vehicle planed direction is the perpendicular direction. The lateral overlap rate can be represented in the perpendicular direction. For the overlap area of the two position points, if the lateral overlap rate is higher, the found adjacent position point is closer to the position point of the second image.

After the aerial vehicle determines the adjacent position point, the aerial vehicle can obtain the fifth image corresponding to the adjacent position point.

At S603, the aerial vehicle determines the third position-attitude change according to the fifth image and the second image.

The third position-attitude change is used to indicate the change of the position-attitude when the vision sensor captures the second image as compared to the position-attitude when the vision sensor captures the fifth image.

The positioning information when the aerial vehicle captures an image is the positioning information determined by the positioning sensor of the aerial vehicle.

In some embodiments, the aerial vehicle can obtain the fifth image and perform processes of the initial matching, matching pair filtering, guided matching, position-attitude calculation, 3D point cloud calculation, etc., to obtain the third position-attitude change. The specific process may be referred to the corresponding processes described above, which is not repeated here.

In some embodiments, the aerial vehicle may determine the position when the aerial vehicle captures the second image according to the third position-attitude change and the position when the aerial vehicle captures the fifth image.

In embodiments of the present disclosure, the aerial vehicle may use the vision sensor to obtain the first image and the second image in real-time. The aerial vehicle can determine the initial feature matching pairs according to the features of the first image and the features of the second image. The aerial vehicle can extract the matching pairs that meet the requirements from the initial feature matching pairs according to the affine transformation model. The aerial vehicle determines the first position-attitude change according to the matching pairs that meet the requirements. The aerial vehicle can filter many matching pairs by using the affine transformation model, such that the first position-attitude change determined subsequently is more accurate, which can improve the accuracy of the position-attitude change and improve the accuracy of the position of the aerial vehicle.

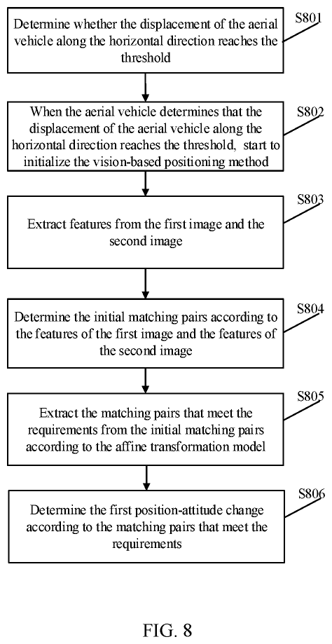

FIG. 8 illustrates a schematic flowchart of another vision-based positioning method according to some embodiments of the present disclosure. The method shown in FIG. 8 includes the following processes.

At S801, the aerial vehicle determines whether the displacement of the aerial vehicle along the horizontal direction reaches the threshold.

In some embodiments, when the aerial vehicle starts to fly, the aerial vehicle may adjust the position-attitude of the aerial vehicle by rotating at the place, flying high, etc. These adjustments lead to abnormal initialization of this vision-based positioning. Therefore, the aerial vehicle can determine according to these adjustments to ensure a normal initialization of the vision-based positioning method.

In some embodiments, the displacement of the aerial vehicle along the horizontal direction may include two situations. In the first situation, the aerial vehicle flies along the horizontal direction. In the second situation, the aerial vehicle may fly along an obliquely upward direction, that is, the aerial vehicle may have displacement components in both the horizontal and vertical directions.

In some embodiments, the determining process may include determining whether the displacement of the aerial vehicle along the horizontal direction reaches the threshold through the method of obtaining the position-attitude change of the aerial vehicle through the vision sensor or other methods.

The threshold may be any value, which is not limited by embodiments of the present disclosure.

At S802, when the aerial vehicle determines that the displacement of the aerial vehicle along the horizontal direction reaches the threshold, the aerial vehicle starts to initialize the vision-based positioning method.

In some embodiments, the initialization of the vision-based positioning method may include obtaining the third image and the fourth image, and obtaining the second position-attitude change according to the features of the third image and the features of the fourth image. The second position-attitude change is used to indicate the change of the position-attitude when the vision sensor captures the fourth image as compared to the position-attitude when the vision sensor captures the third image. The initialization result includes the second position-attitude change.

The third image and the fourth image may be the images obtained by the aerial vehicle at the beginning of the flight. The third image and the fourth image are used to initialize the vision-based positioning method.

In some embodiments, obtaining the second position-attitude change according to the features of the third image and the features of the fourth image includes using the second predetermined algorithm to determine the initial matching pairs according to the features of the third image and the features of the fourth image, obtaining the effective matching pairs and the model parameters of the predetermined constraint model according to the initial matching pairs and the predetermined constraint model, and obtaining the second position-attitude change according to the effective matching pairs and the model parameters of the predetermined constraint model.

In some embodiments, the aerial vehicle may obtain the 3D point cloud map of the second image according to the effective matching pairs and the model parameters of the predetermined constraint model. The aerial vehicle can store the second position-attitude change and the 3D point cloud map of the second image as initialized results.

In some embodiments, the predetermined constraint model includes the homography constraint model and the polarity constraint model.

For example, the aerial vehicle can extract the features of the third image and the features of the fourth image and match the features of the third image and the features of the fourth image to obtain the multiple pairs of the initial matching pairs. The aerial vehicle may input the multiple pairs of initial matching pairs, the homography constraint model, and the polarity constraint model to the second predetermined algorithm for the corresponding algorithm processing to filter the effective matching pairs and obtain the model parameters of the homography constraint model or the model parameters of the polarity constraint model.

In some embodiments, when the aerial vehicle is in a scene of the parallel photographing, the homography constraint model is more stable than the polarity constraint model. Therefore, when the aerial vehicle is in the scene of the parallel photographing, the aerial vehicle can obtain the model parameters of the homography constraint model during the initialization process.

In some embodiments, the aerial vehicle can decompose the model parameters of the homography constraint model or the model parameters of the polarity constraint model and combine a triangulation method to calculate to obtain the second position-attitude change and the 3D point cloud map of the second image.

At S803, the aerial vehicle extracts features from the first image and the second image.

The first image and the second image are the images obtained by the vision sensor.

At S804, the aerial vehicle determines the initial matching pairs according to the features of the first image and the features of the second image.

At S805, the aerial vehicle extracts the matching pairs that meet the requirements from the initial matching pairs according to the affine transformation model.

At S806, the aerial vehicle determines the first position-attitude change according to the matching pairs that meet the requirements.

The first position-attitude change is used to indicate the change of the position-attitude when the vision sensor captures the second image as compared to the position-attitude when the vision sensor captures the first image.

For the specific implementation processes of the processes S803 to S806, reference may be made to the related description of the above method embodiments corresponding to the processes S501 to S504, which are not repeated here.

In accordance with embodiments of the present disclosure, when the aerial vehicle determines that the displacement of the aerial vehicle in the horizontal direction reached the threshold, the aerial vehicle starts to initialize the vision-based positioning method. As such, the aerial vehicle can ensure that the subsequently obtained position-attitude change has higher accuracy. Thus, the calculated position of the aerial vehicle is more accurate.

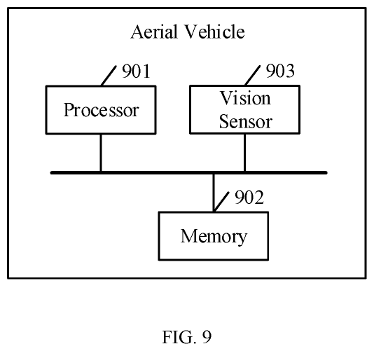

Embodiments of the present disclosure provide an aerial vehicle. FIG. 9 illustrates a schematic structural diagram of an aerial vehicle according to some embodiments of the present disclosure. The aerial vehicle includes a processor 901, a memory 902, and a vision sensor 903. The vision sensor 903 is configured to obtain an image. The memory 902 is configured to store program instructions. The processor 901 is configured to execute the program instructions stored in the memory 902. When executed by the processor 901, the program instructions cause the processor to extract the features from the first image and the second image, determine the initial matching pairs according to the features of the first image and the features of the second image, extract the matching pairs that meet the requirements from the initial matching pairs according to the affine transformation model, and determine the first position-attitude change according to the matching pairs that meet the requirements. The first image and the second image are obtained by the vision sensor 903. The first position-attitude change is used to indicate the change of the position-attitude when the vision sensor 903 captures the second image as compared to the position-attitude when the vision sensor captures the first image.

In some embodiments, the features include the ORB feature points.

In some embodiments, the features include the feature lines.

In some embodiments, to determine the initial matching pairs according to the features of the first image and the features of the second image, the processor 901 is configured to determine the initial matching pairs according to the Hamming distance between the feature descriptors of the second image and the feature descriptors of the first image.

In some embodiments, to determine the initial matching pairs according to the Hamming distance between the feature descriptors of the second image and the feature descriptors of the first image, the processor 901 is configured to match the target feature descriptor of the second image with the feature descriptors of the first image to obtain the corresponding feature descriptor with the closest Hamming distance to the target feature descriptor, and if the Hamming distance between the target feature descriptor and the corresponding feature descriptor is less than the distance threshold, determine the feature corresponding to the target descriptor and the feature corresponding to the corresponding descriptor as the pair of initial matching pairs.

In some embodiments, to extract the matching pairs that meet the requirements from the initial matching pairs according to the affine transformation model, the processor 901 is configured to use the first predetermined algorithm to obtain the matching pairs that meet the requirements according to the affine transformation model and the initial matching pairs and the current model parameters of the affine transformation model.

In some embodiments, to determine the first position-attitude change according to the matching pairs that meet the requirements, the processor 901 is configured to determine the quantity of the matching pairs that meet the requirements, if the quantity of the matching pairs meeting the requirements is less than the predetermined quantity threshold, perform the guided matching on the features of the first image and the features of the second image according to the current model parameters of the affine transformation model to obtain the new matching pairs, and determine the first position-attitude change according to the new matching pairs. The quantity of the new matching pairs is larger than or equal to the quantity of the matching pairs that meet the requirements.

In some embodiments, before to extract the features from the first image and the second image, the processor 901 is also configured to determine whether the current displacement of the aerial vehicle along the horizontal direction reaches the threshold, and when the processor determines that the current displacement of the aerial vehicle along the horizontal direction reaches the threshold, start to initialize the vision-based positioning aerial vehicle.

In some embodiments, to initialize the vision-based positioning aerial vehicle, the processor 901 is configured to obtain the third image and the fourth image, and obtain the second position-attitude change according to the features of the third image and the features of the fourth image. The second position-attitude change is used to indicate the change of the position-attitude when the vision sensor 903 captures the fourth image as compared to the position-attitude when the vision sensor captures the third image. The initialization result includes the second position-attitude change.

In some embodiments, to obtain the second position-attitude change according to the features of the third image and the features of the fourth image, the processor 901 is configured to use the second predetermined algorithm to determine the initial feature matching pairs according to the features of the third image and the features of the fourth image, obtain the effective feature matching pairs and the model parameters of the predetermined constraint model according to the initial feature matching pairs and the predetermined constraint model, and obtain the second position-attitude change according to the effective feature matching pairs and the model parameters of the predetermined constraint model.

In some embodiments, the predetermined constraint model includes the homography constraint model and the polarity constraint model.

In some embodiments, to determine the first position-attitude change according to the matching pairs that meet the requirements, the processor 901 is configured to use the epipolar geometry algorithm to obtain the initial value of the first position-attitude change according to the matching pairs that meet the requirements, and use the predetermined optimization algorithm to perform the optimization processing according to the initial value of the first position-attitude change and the matching pairs that meet the requirements to determine the first position-attitude change.

In some embodiments, to use the epipolar geometry algorithm to obtain the initial value of the first position-attitude change according to the matching pairs that meet the requirements, the processor 901 is configured to use the PNP algorithm to obtain the initial value of the first position-attitude change according to the matching pairs that meet the requirements.

In some embodiments, the processor 901 is further configured to use the epipolar geometry algorithm to obtain the initial value of the 3D point cloud map of the second image according to the matching pairs that meet the requirements. To perform the optimization processing through the predetermined optimization algorithm according to the initial value of the first position-attitude change and the matching pairs that meet the requirements to obtain the first position-attitude change, the processor 901 is configured to perform the optimization processing through the predetermined optimization algorithm according to the initial value of the first position-attitude change, the initial vale of the 3D point cloud map of the second image, and the matching pairs that meet the requirements to determine the first position-attitude change and the 3D point cloud map of the second image.

In some embodiments, the aerial vehicle stores the multiple images and the positioning information when the aerial vehicle captures each of the images. The processor 901 is further configured to, when the aerial vehicle cannot determine the first position-attitude change according to the matching pairs that meet the requirements, determine the positioning information when the aerial vehicle captures the second image, determine the fifth image according to the positioning information and the positioning information corresponding to the multiple images, and determine the third position-attitude change according to the fifth image and the second image. The fifth image is the image with the positioning information closest to the positioning information of the second image beside the first image. The third position-attitude change is used to indicate the change of the position-attitude when the vision sensor 903 captures the second image as compared to the position-attitude when the vision sensor 903 captures the fifth image.

The positioning information when the aerial vehicle captures each of the images is the positioning information determined by the positioning sensor of the aerial vehicle.

The above method embodiments are described by a series of combinations of operations for a simple description. However, those skilled in the art should know that the present disclosure is not limited by the sequence of the operations, because according to the present disclosure, some processes may be performed in other sequences or simultaneously. Those skilled in the art should also know that the embodiments described in the specification are all specific embodiments, and the operations and modules involved are not necessarily required by the present disclosure.

Those of ordinary skill in the art may understand that all or part of the processes in the methods of the above embodiments may be implemented by a program instructing related hardware. The program may be stored in a computer-readable storage medium. The storage medium may include a flash drive, read-only memory (ROM), random access memory (RAM), magnetic disk, optical disk, etc.

The vision-based positioning method and aircraft provided by embodiments of the present disclosure are described in detail above. Specific examples are used in the specification to explain the principles and implementations of the present disclosure. The descriptions of the above embodiments are merely to help understand the methods of the present disclosure and its core idea. For those of ordinary skill in the art, according to the idea of the present disclosure, changes may be made to specific implementations and application scope. In summary, the content of this specification should not be understood as a limitation to the present disclosure.

What is claimed is:

1. A vision-based positioning method comprising:
extracting first features from a first image and second features from a second image, the first image and the second image being obtained by a vision sensor carried by an aerial vehicle;
determining initial matching pairs according to the first features and the second features;
extracting satisfying matching pairs that meet a requirement from the initial matching pairs according to an affine transformation model; and
determining a position-attitude change according to the satisfying matching pairs, the position-attitude change indicating a change from a position-attitude of the vehicle when the vision sensor captures the first image to a position-attitude of the vehicle when the vision sensor captures the second image.

2. The method of claim 1, wherein each of the first features and the second features includes an oriented fast and rotated brief (ORB) feature point or a feature line.

3. The method of claim 1, wherein determining the initial matching pairs includes determining the initial matching pairs according to a Hamming distance between feature descriptors of the second image and feature descriptors of the first image.

4. The method of claim 3, wherein determining the initial matching pairs according to the Hamming distance between the feature descriptors of the second image and the feature descriptors of the first image includes:
matching a target feature descriptor of the second image with the feature descriptors of the first image to obtain a corresponding feature descriptor with a closest Hamming distance to the target feature descriptor; and
in response to the Hamming distance between the target feature descriptor and the corresponding feature descriptor being less than a predetermined distance threshold, determining a pair including a feature corresponding to the target feature descriptor and a feature corresponding to the corresponding feature descriptor as one of initial matching pairs.

5. The method of claim 1, wherein extracting the satisfying matching pairs includes obtaining the satisfying matching pairs and current model parameters of the affine transformation model according to the affine transformation model and the initial matching pairs using a predetermined algorithm.

6. The method of claim 5, wherein determining the position-attitude change includes:
determining a quantity of the satisfying matching pairs;
in response to the quantity of the satisfying matching pairs being less than a predetermined quantity threshold, performing guided matching on the first features and the second features according to the current model parameters of the affine transformation model to obtain new matching pairs, a quantity of the new matching pairs being larger than or equal to the quantity of the satisfying matching pairs; and
determining the position-attitude change according to the new matching pairs.

7. The method of claim 1, further comprising, before extracting the first features and the second features:
determining whether a horizontal displacement of the aerial vehicle along a horizontal direction reaches a threshold; and
in response to the horizontal displacement being determined to have reached the threshold, starting an initialization process.

8. The method of claim 7, wherein:
the position-attitude change is a first position-attitude change; and
the initialization process includes:
obtaining a third image and a fourth image; and
obtaining a second position-attitude change according to features of the third image and features of the fourth image, the second position-attitude change indicating a change from a position-attitude of the aerial vehicle when the vision sensor captures the third image to a position-attitude of the aerial vehicle when the vision sensor captures the fourth image.

9. The method of claim 8, wherein obtaining the second position-attitude change includes:
determining initial feature matching pairs according to the features of the third image and the features of the fourth image using a predetermined algorithm;
obtaining effective feature matching pairs and model parameters of a predetermined constraint model according to the initial feature matching pairs and the predetermined constraint model; and
obtaining the second position-attitude change according to the effective feature matching pairs and the model parameters of the predetermined constraint model.

10. The method of claim 9, wherein the predetermined constrain model includes a homography constraint model or a polarity constraint model.

11. The method of claim 1, wherein determining the position-attitude change includes:
obtaining an initial value of the position-attitude change according to the satisfying matching pairs using an epipolar geometry algorithm; and
performing optimization processing according to the initial value and the satisfying matching pairs using a predetermined optimization algorithm to determine the position-attitude change.

12. The method of claim 11, obtaining the initial value according to the satisfying matching pairs using the epipolar geometry algorithm includes obtaining the initial value according to the satisfying matching pairs using a perspective-n-point (PnP) algorithm.

13. The method of claim 11, further comprising:
obtaining an initial value of a 3D point cloud map of the second image according to the satisfying matching pairs using the epipolar geometry algorithm;
wherein performing the optimization processing according to the initial value of the position-attitude change and the satisfying matching pairs using the predetermined optimization algorithm to determine the position-attitude change includes performing the optimization processing according to the initial value of the position-attitude change, the initial value of the 3D point cloud map, and the satisfying matching pairs using the predetermined optimization to determine the position-attitude change and the 3D point cloud map of the second image.

14. The method of claim 1, further comprising, in response to failing to determine the position-attitude change:
determining a position of the aerial vehicle when capturing the second image;
determining, from a plurality of images stored in the aerial vehicle not including the first image and the second image, a closest image according to the position of the aerial vehicle and positions of the aerial vehicle corresponding to the plurality of images, the position corresponding to the closest image being closest to the position corresponding to the second image among the plurality of images; and
determining another position-attitude change according to the closest image and the second image, the another position-attitude change indicating a change from a position-attitude of the aerial vehicle when the vision sensor captures the closest image to the position-attitude of the aerial vehicle when the vision sensor captures the second image.

15. An aerial vehicle comprising:
a vision sensor configured to obtain a first image and a second image;
a processor; and
a memory storing program instructions that, when executed by the processor, cause the processor to:
extract first features from a first image and second features from a second image, the first image and the second image being obtained by a vision sensor carried by an aerial vehicle;
determine initial matching pairs according to the first features and the second features;
extract satisfying matching pairs that meet a requirement from the initial matching pairs according to an affine transformation model; and
determine a position-attitude change according to the satisfying matching pairs, the position-attitude change indicating a change from a position-attitude of the vehicle when the vision sensor captures the first image to a position-attitude of the vehicle when the vision sensor captures the second image.

16. The aerial vehicle of claim 15, wherein each of the first features and the second features includes an oriented fast and rotated brief (ORB) feature point and feature line.

17. The aerial vehicle of claim 15, wherein the program instructions cause the processor further to:
determine the initial matching pairs according to a Hamming distance between feature descriptors of the second image and feature descriptors of the first image.

18. The aerial vehicle of claim 17, wherein the program instructions cause the processor further to:
match a target feature descriptor of the second image with the feature descriptors of the first image to obtain a corresponding feature descriptor with a closest Hamming distance to the target feature descriptor; and
in response to the Hamming distance between the target feature descriptor and the corresponding feature descriptor being less than a predetermined distance threshold, determine a pair including a feature corresponding to the target feature descriptor and a feature corresponding to the corresponding feature descriptor as one of initial matching pairs.

19. The aerial vehicle of claim 15, wherein the program instructions cause the processor further to:
obtain the satisfying matching pairs and current model parameters of the affine transformation model according to the affine transformation model and the initial matching pairs using a predetermined algorithm.

20. The aerial vehicle of claim 19, wherein the program instructions cause the processor further to:
determine a quantity of the satisfying matching pairs;
in response to the quantity of the satisfying matching pairs being less than a predetermined quantity threshold, perform guided matching on the first features and the second features according to the current model parameters of the affine transformation model to obtain new matching pairs, a quantity of the new matching pairs larger than or equal to the quantity of the satisfying matching pairs; and
determine the position-attitude change according to the new matching pairs.
